(19) United States
(12) Patent Application Publication
(10) Pub. No.: US 2007/0047755 A1
(43) Pub. Date: Mar. 1, 2007

(54) Diffuser, speaker device, and method of manufacturing speaker device

(75) Inventors: Tetsuya Onuma, Yamagata (JP); Yutaka Moriyama, Yamagata (JP)

Correspondence Address: SUGHRUE-265550, 2100 PENNSYLVANIA AVE. NW, WASHINGTON, DC, 20037-3213, US

(73) Assignees: PIONEER CORPORATION; TOHOKU PIONEER CORPORATION

(21) Appl. No.: 11/210,753

(22) Filed: Aug. 25, 2005

(30) Foreign Application Priority Data
Aug. 25, 2005 (JP) P2004-245924

(51) Int. Cl. H04R 9/06; H04R 11/02; H04R 1/00

(52) U.S. Cl. 381/412

(57) ABSTRACT

A speaker device which makes it possible to prevent the entry of foreign matter such as magnetic dust into a magnetic gap through the gap between a diffuser and a voice coil bobbin, to thereby improve the operational reliability and service life of the product. In a speaker device in which a diffuser that improves directional characteristics is provided on a front side of a center pole that makes up a magnetic circuit, the diffuser has a magnet portion which is provided in a ring shape making one round around its outer periphery and is magnetized in a radial direction. As foreign matter such as magnetic dust is attracted by the magnet portion of the diffuser, the entry of the foreign matter into a magnetic gap side is prevented.

### BACKGROUND OF THE INVENTION

1. Field of the Invention

The present invention relates to a diffuser, a speaker device, and a method of manufacturing a speaker device.

2. Description of the Related Art

FIG. 1 shows a conventional example of a dynamic speaker device having a diffuser for improving directional characteristics.

This speaker device 1 is configured by including a magnetic circuit 3, a frame 5 with this magnetic circuit 3 attached to its rear, a cone-shaped diaphragm 9 whose outer peripheral roll-shaped edge 7 is fixed to an edge supporting portion 5a at a front of the frame 5, a voice coil 12 wound around a cylindrical voice coil bobbin 11, and a diffuser 13 for improving the directional characteristics by diffusing the sound generated by the diffuser 9.

The magnetic circuit 3 includes a yoke 15 having a cylindrical outer cylinder portion 15b formed integrally on an outer periphery of a disk-shaped plate portion 15a, a disk-shaped magnet 16 bonded to the front surface of the plate portion 15a, and a top plate 17 bonded on top of this magnet 16. In this magnetic circuit 3, a columnar structure formed by the plate portion 15a, the magnet 16, and the top plate 17 functions as a center pole 3a in which the voice coil bobbin 11 is loosely fitted, the gap between an outer periphery of the top plate 17 and the outer cylinder portion 15b being formed as a magnetic gap 19 for disposing the voice coil 12.

The diaphragm 9 has an opening formed in its center for the insertion of the voice coil bobbin 11 therethrough. An inner peripheral edge of the diaphragm 9 which forms the opening is fixed to an outer periphery of the voice coil bobbin 11 inserted in the opening.

In addition, the cylindrical voice coil bobbin 11 is loosely fitted to an outer periphery of the center pole 3a movably in the axial direction, and is resiliently supported by the frame 5 through a damper 25 so that its axial movement is restricted.

The damper 25 is formed with a bellows structure (corrugated structure) in which projections and recesses are alternately arranged in a radial direction, and is called a corrugated damper.

This damper 25 has its outer peripheral edge fixed to a damper supporting portion 5b of the frame 5 and its inner peripheral edge fixed to the outer periphery of the voice coil bobbin 11 so as to restrict the radial displacement of the voice coil bobbin 11. When the diaphragm 9 is driven, the damper 25 absorbs the vibrational energy through the deformation of the bellows to damp the diaphragm 9.

A signal is inputted to the voice coil 12 through a voice coil lead wire connected to an input terminal 29 of the frame 5. The diaphragm 9 is vibrated by the reciprocating vibration of the voice coil bobbin 11 in response to the input signal to the voice coil 12 to thereby effect acoustic reproduction.

The diffuser 13 is formed into a predetermined shape by a single part or a plurality of parts made of a nonmagnetic material. In the case of the illustrated example, the diffuser 13 is bonded and fixed to a front end face of the center pole 3a (e.g., refer to JP-A-2003-333688).

However, in the case of the speaker device 1 having the diffuser 13 on the front side of the center pole 3a, as described above, the opening at the center of the diaphragm 9 cannot be covered by a dust cap in the light of its structure.

Accordingly, the magnetic gap 19 is in a state of communication with the outside through the gap between the diffuser 13 and the voice coil bobbin 11. For this reason, in a case where foreign matter such as magnetic dust has been carried to the surroundings of the diffuser 13 by, for example, an air stream produced by such as the vibration of the diaphragm 9 or a circulating air stream in the room where the speaker is installed, there has been a possibility that the foreign matter such as the magnetic dust is carried by the air stream and enters the interior of the magnetic gap 19, leading to a failure or faulty operation ascribable to the attachment of the foreign matter in the magnetic gap 19.

### SUMMARY OF THE INVENTION

The invention provides a diffuser which makes it possible to prevent the entry of foreign matter such as magnetic dust into the magnetic gap through the gap between the diffuser and the voice coil bobbin, to thereby improve the operational reliability and service life of the product, as well as a speaker device having the diffuser.

According to an aspect of the present invention, a diffuser that improves directional characteristics of a speaker, includes a magnet portion magnetized in a radial direction.

According to an aspect of the present invention, a speaker device includes a diffuser provided on a front side of a center pole that makes up a magnetic circuit. The diffuser includes a magnet portion magnetized in a radial direction.

According to an aspect of the present invention, a method of manufacturing a speaker device includes magnetizing a magnet portion of a diffuser in a radial direction, providing the magnet portion in a ring shape which makes one round around an outer periphery of a diffuser body, assembling a vibration system part to a frame joined to a magnetic circuit that drives a diaphragm, and joining the diffuser to a front end face of a center pole of the magnetic circuit exposed in a central opening of the diaphragm.

### BRIEF DESCRIPTION OF THE DRAWINGS

FIG. 1 is a perspective view, partly in section, of a conventional example of a speaker device having a diffuser;

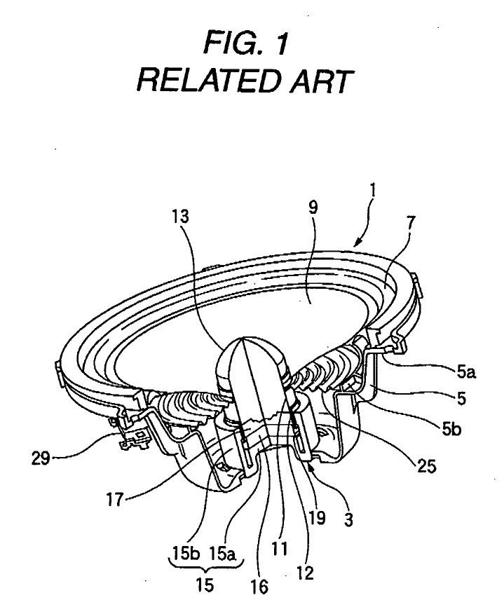

FIG. 2 is a perspective view, partly in section, of a speaker device in accordance with an embodiment of the invention; and

FIG. 3 is an exploded perspective view of the diffuser shown in FIG. 2.

### DETAILED DESCRIPTION OF THE INVENTION

Referring now to the drawings, a detailed description will be given of a diffuser, a speaker device, and a method of manufacturing a speaker device in accordance with an embodiment of the invention.

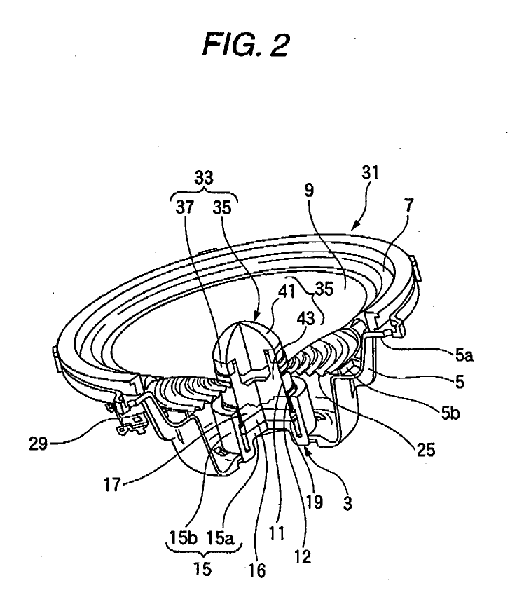

FIG. 2 is a perspective view, partly in section, of the speaker device in accordance with the embodiment of the invention.

A speaker device 31 of this embodiment is configured by including a magnetic circuit 3, a frame 5 with this magnetic circuit 3 attached to its rear, a cone-shaped diaphragm 9 whose outer peripheral roll-shaped edge 7 is fixed to an edge supporting portion 5a at a front of the frame 5, a voice coil 12 wound around a cylindrical voice coil bobbin 11, and a diffuser 33 for improving directional characteristics by diffusing the sound generated by the diffuser 9.

Component parts other than the diffuser 33 may be identical to those of the conventional speaker device shown in FIG. 2, the parts identical to the conventional parts will be denoted by the same reference numerals, and a description thereof will be simplified or omitted.

The diffuser 33 is fitted to the front side of a center pole 3a which is formed by a plate portion 15a of the magnetic circuit 3, a magnet 16, and a top plate 17, and improves the directional characteristics by diffusing the sound generated by the diffuser 9.

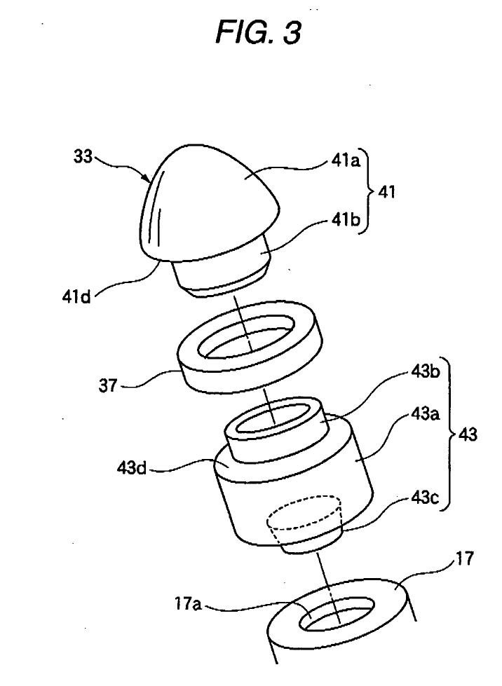

In the case of this embodiment, as shown in FIGS. 2 and 3, the diffuser 33 is comprised of a diffuser body 35 made of a nonmagnetic material and a magnet portion 37 formed in a ring shape making one round around the outer periphery of this diffuser body 35 and magnetized in the radial direction.

As shown in FIG. 3, the diffuser body 35 is comprised of two parts, a distal end member 41 and a rear end member 43 fitted and joined to a rear end of the distal end member 41.

The distal end member 41 has a spherical or cone-shaped distal end portion 41a and a fitting shank portion 41b of a diameter smaller than that of this distal end portion 41a. Meanwhile, the rear end member 43 has a body shank portion 43a of an outside diameter substantially identical to that of a maximum outside diameter portion of the distal end portion 41a of the distal end member 41, a hollow cylindrical portion 43b projecting from a tip of this body shank portion 43a, and a positioning shank portion 43c projecting from a rear end of the body shank portion 43a.

The inside diameter of the hollow cylindrical portion 43b is set to be substantially equal to the outside diameter of the fitting shank portion 41b. As the fitting shank portion 41b is fitted to the hollow cylindrical portion 43b, the distal end member 41 and the rear end member 43 are joined together. In addition, the outside diameter of the hollow cylindrical portion 43b is set to be slightly smaller than the inside diameter of the ring-shaped magnet portion 37, and the magnet portion 37 is fitted over the outer periphery of the hollow cylindrical portion 43b. The magnet portion 37 fitted over the outer periphery of the hollow cylindrical portion 43b is clamped and fixed by a front end face 43d of the body shank portion 43a and a rear end face 41d of the distal end portion 41a.

As the positioning shank portion 43c is fitted in a positioning recess 17a formed in the center of the top plate 17, the positioning shank portion 43c is positioned on the top plate 17 such that their center axes are aligned.

The rear end member 43 is bonded and fixed to the top plate 17 as the rear end member 43 is positioned on the top plate 17 in a state in which, for example, an adhesive is applied to the positioning shank portion 43c and a rear end face of the body shank portion 43a.

The above-described speaker device 31 is assembled in the following procedure.

First, the magnetic circuit 3 is assembled to the frame 5, and magnetization treatment of the magnetic circuit 3 is carried out. Subsequently, the diaphragm 9, the voice coil 12, and the like, which are vibration system parts, are assembled to the magnetic circuit 3 and the frame 5. After bonded portions are dried, a performance test is conducted without the diffuser 33.

Next, the diffuser 33, which has been obtained by assembling in advance the distal end member 41, the rear end member 43, and the magnet portion 37 and for which the magnet portion 37 has been magnetized, is bonded and fixed to the top plate 17. The speaker device 31 in which the diffuser 33 is thereby joined to the center pole 3a is thus completed.

With the above-described speaker device 31 as well, a magnetic gap 19 where the voice coil 12 is disposed is in a state of communication with the outside through the gap between the diffuser 13 and the voice coil bobbin 11.

However, the magnetic force of the ring-shaped magnet portion 37 provided around the outer periphery of the diffuser 33 acts in the gap between the diffuser 13 and the voice coil bobbin 11. Therefore, foreign matter such as the magnetic dust which entered the gap between the diffuser 13 and the voice coil bobbin 11 is attracted by the magnetic force of the magnet portion 37, and does not reach the magnetic gap 19.

Namely, the foreign matter such as the magnetic dust is prevented from entering the interior of the magnetic gap 19 through the gap between the diffuser 33 and the voice coil bobbin 11, thereby making it possible to prevent the occurrence of a failure or faulty operation ascribable to the attachment of the foreign matter in the magnetic gap 19.

In addition, in the method of manufacturing the above-described speaker device 31, the mounting of the diffuser 33 on the center pole 3a is effected after assembling the diaphragm 9 to the frame 5. Therefore, the diffuser 33 does not constitute an obstruction during the assembling operation of the diaphragm 9, and the assembling operation can be performed smoothly, thereby making it possible to improve the productivity of the speaker device 31.

In addition, with the speaker device 31 in accordance with this embodiment, the diffuser 33 adopts a three-piece structure in which the ring-shaped magnet portion 37 is sandwiched by the distal end member 41 and the rear end member 43, which are a pair of parts made of a nonmagnetic material. The arrangement provided is such that the pair of parts 41 and 43 made of the nonmagnetic material and sandwiching the magnet portion 37 are integrated by being fitted together in the direction of sandwiching the magnet portion 37. Therefore, the assembling efficiency can be made excellent, and it is possible to improve productivity and attain a reduction in cost.

It should be noted that in the above-described embodiment the structure adopted is such that the diffuser 33 is secured to the front end face of the center pole 3a by bonding.

However, the means of fixing the diffuser 33 to the center pole 3a is not limited to bonding. For example, as the means of fixing the diffuser 33 to the center pole 3a, it is possible to use fastening by using a screw member.

In addition, the mounting of the diffuser 33 is not limited to the direct joining to the front end face of the center pole 3a.

For example, it is conceivable to adopt a structure in which the diffuser 33 is fixed to a bridge or the like secured to the frame 5, in such a manner as to traverse the front side of the diaphragm 9.

In addition, in the case of the diffuser 33 of the above-described embodiment, although the position where the magnet portion 37 is fitted is a position offset closer to the front side of the speaker than the inner peripheral edge of the diaphragm 9, the position where the magnet portion 37 is fitted may be set slightly closer to the magnetic circuit 3 side on condition that the magnet portion 37 does not affect the magnetic field formed by the magnetic circuit 3.

As described above, the diffuser in accordance with the embodiment of the invention includes the magnet portion magnetized in the radial direction, and the speaker device of this embodiment is provided with this diffuser on the front side of the center pole for making up the magnetic circuit.

Consequently, the magnetic gap where the voice coil is disposed is in a state of communication with the outside through the gap between the diffuser and the voice coil bobbin. However, the magnetic force of the ring-shaped magnet portion provided around the outer periphery of the diffuser acts in the gap between the diffuser and the voice coil bobbin. Therefore, foreign matter such as the magnetic dust which entered the gap between the diffuser and the voice coil bobbin is attracted by the magnetic force of the magnet portion, and does not reach the magnetic gap. Namely, the foreign matter such as the magnetic dust is prevented from entering the interior of the magnetic gap through the gap between the diffuser and the voice coil bobbin, thereby making it possible to prevent the occurrence of a failure or faulty operation ascribable to the attachment of the foreign matter in the magnetic gap.

Accordingly, it is possible to improve the operational reliability and service life of the product.

Furthermore, with the method of manufacturing a speaker device in accordance with this embodiment, after completion of the assembling of vibration system parts such as the diaphragm and the voice coil to the frame joined to the magnetic circuit for driving the diaphragm, this diffuser is joined to the front end face of the center pole of the magnetic circuit exposed in the central opening of the diaphragm.

Consequently, the mounting of the diffuser on the center pole is effected after assembling the diaphragm to the frame. Therefore, the diffuser does not constitute an obstruction during the assembling operation of the diaphragm, and the assembling operation can be performed smoothly, thereby making it possible to improve the productivity of the speaker device.

In addition, the diffuser adopts a three-piece structure in which, for example, the ring-shaped magnet portion is sandwiched by the pair of parts made of a nonmagnetic material, and the arrangement provided is such that the pair of parts made of the nonmagnetic material and sandwiching the magnet portion are integrated by being fitted together in the direction of sandwiching the magnet. Therefore, the assembling efficiency can be made excellent, and it is possible to improve productivity and attain a reduction in cost.

What is claimed is:

1. A diffuser that improves directional characteristics of a speaker, comprising:
a magnet portion magnetized in a radial direction.

2. The diffuser according to claim 1,
wherein the magnet portion is provided in a ring shape which makes one round around an outer periphery of a diffuser body.

3. A speaker device comprising:
a diffuser provided on a front side of a center pole that makes up a magnetic circuit,
wherein the diffuser includes a magnet portion magnetized in a radial direction.

4. The speaker device according to claim 3,
wherein the magnet portion is provided in a ring shape making one round around an outer periphery of a diffuser body.

5. A method of manufacturing a speaker device comprising:
magnetizing a magnet portion of a diffuser in a radial direction;
providing the magnet portion in a ring shape which makes one round around an outer periphery of a diffuser body;
assembling a vibration system part to a frame joined to a magnetic circuit that drives a diaphragm; and
joining the diffuser to a front end face of a center pole of the magnetic circuit exposed in a central opening of the diaphragm.
